(19) United States
(12) Patent Application Publication
(10) Pub. No.: US 2018/0307825 A1
(43) Pub. Date: Oct. 25, 2018

(54) DEVICE, SYSTEM, AND METHOD FOR SECURE REPLICATION OF VEHICLE ACCESS DEVICES

(71) Applicant: HY-KO PRODUCTS COMPANY, Northfield, OH (US)

(72) Inventors: Timothy J. O'Hearn, Shaker Heights, OH (US); William R. Mutch, North Ridgeville, OH (US)

(21) Appl. No.: 15/958,466

(22) Filed: Apr. 20, 2018

Related U.S. Application Data
(60) Provisional application No. 62/487,505, filed on Apr. 20, 2017.
(60) Provisional application No. 62/500,086, filed on May 2, 2017.
(60) Provisional application No. 62/546,076, filed on Aug. 16, 2017.

(51) Int. Cl. G06F 21/44; G06F 21/31; B60R 25/04; G06F 3/048; B60R 25/20

(52) U.S. Cl. CPC G06F 21/44; G06F 21/31; B60R 25/2009; G06F 3/048; B60R 25/04

(57) ABSTRACT

A secure system for replication of a personal access device to function with a vehicle having an immobilizer system, the system including a console configured to receive information selected from one or more of the categories of vehicle identity data, customer identity data and processor identity data and having a communication link. A processor tool having processor and a communication link. A communication link between said console and said processor tool configured to communicate selected data to the tool. A logic configured to communicate selected portions of said input data and a secure memory configured to store selected portions of said data and transmit confirmation of such storage to enable operation of said processor tool. The features can be distributed in a network or embodied in a single unitary device.

### CROSS-REFERENCE TO RELATED APPLICATIONS

This application claims priority to Provisional Patent Application No. 62/487,505 entitled “DEVICE, SYSTEM, AND METHOD FOR SECURE REPLICATION OF VEHICLE ACCESS DEVICES” filed on Apr. 20, 2017 and claims priority to Provisional Patent Application No. 62/500,086 entitled “DEVICE, SYSTEM, AND METHOD FOR SECURE REPLICATION OF VEHICLE ACCESS DEVICES” filed on May 2, 2017 and claims priority to Provisional Patent Application No. 62/546,076 entitled “DEVICE, SYSTEM, AND METHOD FOR SECURE REPLICATION OF VEHICLE ACCESS DEVICES” filed on Aug. 16, 2017, each of which are hereby incorporated by reference in their entireties.

### FIELD OF THE INVENTION

The present invention is generally related to a system and method for the secure replacement, generation, or reprogramming of vehicle access devices, such as transponder keys or remotes.

### BACKGROUND

Most vehicles include an engine control module (ECM) that controls access and operation of the vehicle. A regular component of an ECM is an immobilizer system. The immobilizer system prevents the vehicle from opening, starting and operating unless and until an authorized key is placed within or near the vehicle or otherwise communicates with the vehicle.

These systems involve wireless communication of codes, typically using radio communications or close field connection like transformer inductance. Vehicle access devices and immobilizer systems often involve a transponder component or other feature that operates through such electromagnetic radiation. These systems include an electronic security device fitted to an automobile that prevents the engine from running unless the transponder key is present. This reduces the risk of a vehicle from being “hot wired” after entry has been achieved and thus reduces motor vehicle theft. When the transponder key with the proper code is inserted in the vehicle ignition switch, for example, or comes within close proximity of the vehicle, it communicates codes with the electronic control module and the immobilizer system to unlock and activate the vehicle.

Most vehicle manufacturers have developed their own system for this combination of immobilizer electronics and corresponding key, remote, or similar device. From time to time, a vehicle owner will lose or break these devices or need an additional one to operate the vehicle and need to purchase a new one. This can be complicated and be vulnerable to fraud, deceit, inattention, or missteps that can create the opportunity for a form of identity theft, vehicle theft, or criminal mischief.

For example, some immobilizer access tools use hacking techniques on certain vehicle models to bypass the original equipment manufacturer (OEM) security protocol of that vehicle (e.g. PIN codes and/or time delays). This enables access to the vehicle's ECM to reprogram to accept a new access device. For example, a valet driver could route a vehicle to an accomplice with such a tool and, in a matter of minutes, reprogram the vehicle to accept a new key that would be used later when the accomplice follows the driver home and steals the car with no means of tracing the culprits.

Even for those cases where there are no preexisting hacking techniques, standard control systems like the National Automobile Service Task Force (NASTF) Registry and Secure Data Release Model (SDRM) leave room for abuse. Under that system, only registered SDRM professionals are granted access to reprogramming passwords. However, that has not stopped “brokers” of access codes from arising who put security in jeopardy. In addition, even in states where the use of such tools is limited to licensed locksmiths, a lax user of on-board diagnostic (OBD) tools could reprogram a vehicle without confirming that the holder of the key is authorized by the vehicle owner to have a duplicate key made or properly recording the event. Present systems and methods remain vulnerable to security breaches.

This disclosure provides a secure system for consumers to obtain a new/duplicate vehicle access device while reducing risks of security breaches and with other benefits such as increased flexibility, faster service, and less paperwork. In the past, systems and methods for providing vehicle programming were unable to ensure that adequate traceability data was generated and stored, which led to untraceable identity theft and vehicle thefts. The present disclosure provides a level of security that can solve these problems.

### SUMMARY

The system and method of the present invention captures customer, operator, tool, and vehicle data involved with the creation/origination of a replica or new vehicle access device, and stores relevant data of that event in permanent storage to ensure traceability in a manner that provides a technology based theft prevention means of creating such access devices. The system may lock out its operator unless and until an adequate customer authorization has been verified or a record of the event has been securely stored in memory. The system may be consolidated at one location and operated by one user or may be distributed to multiple locations and operated by multiple users, each performing the process elements distributed to them.

In one embodiment, provided is a computer-implemented method for activation of a personal device to function with a vehicle immobilizer system. The method includes the steps of generating a vehicle identity data set, generating a customer identity data set, and generating a processor identity data set. A processor tool having a processor may be provided having an operator interface and communication links. A transaction data set based on the vehicle identity set and the processor identity set may be retrieved from an authorization source. At least a portion of the vehicle identity data set, the customer identity data set, and said processor identity data set may be transmitted to a storage location and effecting storage of such data. Confirmation of said storage event may be transmitted to the processor tool to enable operation of the tool.

In another embodiment, provided is a system for replication of access devices used with a vehicle having an immobilizer system and a standard connection port or other type of vehicle communications interface. The system comprising a means for inputting customer identity data. A means for inputting vehicle identity data. A means for authenticating ownership or registration of the vehicle by the customer. A logic configured to prevent replication until said authentication has occurred. The logic may be configured to prevent replication until at least a portion of said data has been securely stored.

In another embodiment, provided is a secure system for activation of a personal access device to function with a vehicle having an immobilizer system. The secure system comprising a console at a service location configured to receive data selected from one or more of the categories of vehicle identity data, customer identity data and processor identity data and having a communication link. A processor tool having a communication link. A communication link between said console and said processor tool configured to communicate selected data to the processor tool. A logic configured to communicate selected portions of said input data to an authorization unit and receive a processor transaction data set in response. A secure storage may be configured to store selected portions of said input data and transmit confirmation of such storage to enable operation of said processor tool. The console may include a receptacle configured to receive a master key and a reader configured to collect data selected from the group consisting of physical features of the blade or detected features of the electronic components.

In another embodiment, provided is a secure system for activation of at least one personal access device to function with a vehicle having an immobilizer system. The secure system comprising one or more data collection devices at a service location configured to receive data selected from one or more of the categories of vehicle identity data, customer identity data and processor identity data and having a communication link. A processor tool having a communication link. Said processor could be local or remote. Said communication link could be hardwired or wireless. A remotely located and remotely operated console system. A communication link between said data collection devices, said console and said processor tool configured to communicate selected data to the processor tool. A logic configured to communicate selected portions of said input data to an authorization unit and receive a processor transaction data set in response. A secure storage may be configured to store selected portions of said input data and transmit confirmation of such storage to enable operation of said processor tool.

In yet another embodiment, provided is a computer-implemented method for activation of a personal device to function with a vehicle immobilizer system. The method includes the step of generating a vehicle identity data set, generating a customer identity data set, and generating a processor identity data set. A processor tool having an operator interface and communication links may be provided. Authenticating ownership of said vehicle may be authenticated. Operation of said tool may be blocked until said authentication is complete. A transaction data set may be retrieved from an authorization source based on said vehicle identity set. At least a portion of said vehicle identity data set, said customer identity data set, and said processor identity data set may be transmitted to a storage location to store the data. Confirmation of said storage event may be transmitted to said processor tool to enable operation of the tool.

A further embodiment is provided and includes a secure network of devices for activation of a personal device to function with a vehicle immobilizer system. This system includes a non-transitory computer-readable medium coupled to the computing devices on the network having instructions stored thereon which, when executed by such computing devices, cause the network to perform operations comprising: generating a vehicle identity data set; generating a customer identity data set; generating a processor identity data set. A processor tool having an operator interface and communication links is provided. A transaction data set based on said vehicle identity set and said operator identity set may be retrieved from an authorization source. At least a portion of said vehicle identity data set, said customer identity data set, and said processor identity data set may be transmitted to a storage location and store the data. Confirmation of said storage event may be transmitted to said processor tool to enable operation of the processor tool.

It should be noted that the disclosed methods and system are not constrained by physical location. All elements of the process could be at one physical location or any combination of different locations. For example, in one alternate embodiment, the user at the vehicle location operates the equipment to connect to the vehicle, collect the vehicle identity data, and collect the customer identity data, however, a remotely located security professional operates the system to perform the ownership authentication, obtain the transaction data set from an authorization source, store the portions of vehicle identity data, customer identity data and processor identity data, and enable operation of the tool.

### BRIEF DESCRIPTION OF THE DRAWINGS

The disclosed method and system may be better understood by reference to the following detailed description taken in connection with the following illustrations, wherein:

FIG. 1 is a block diagram of embodiments of a communication framework of a system for secure creation of vehicle access devices in accordance with the present disclosure;

FIG. 2 is a schematic diagram of embodiments of a communication framework of the system for secure programming of vehicle access devices in accordance with the present disclosure;

FIG. 3 is an illustration of embodiments for a system for secure programming of vehicle access devices in accordance with the present disclosure;

FIG. 4 is a diagram that identifies communication between a vehicle and a processor tool in accordance with the present disclosure;

FIG. 5 is a flow chart of one embodiment of a method for the secure programming or replacement of vehicle access devices in accordance with the present disclosure;

FIG. 6 is an embodiment of the processor tool in accordance with the present disclosure;

FIG. 7A is an image of an embodiment of a communication link in accordance with the present disclosure;

FIG. 7B is an image of an embodiment of a communication link in accordance with the present disclosure;

FIG. 8A is an embodiment of a graphic user interface screen shot that may be displayed by the processor tool of FIG. 6;

FIG. 8B is an embodiment of a graphic user interface screen shot that may be displayed by the processor tool of FIG. 6;

FIGS. 9A, 9B, 9C, 9D, 9E, 9F, and 9G illustrate embodiments of graphic user interface screen shots that may be displayed by the processor tool of FIG. 6 to establish authorization to implement the secure programming of vehicle access devices in accordance with the present disclosure; and

FIGS. 10A and 10B illustrate embodiments of graphic user interface screen shots to perform steps of the instant disclosure.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention, including the incorporation into a single unitary device or partitioning into any number of local or remote networked devices. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

The present system described in this application involves components and methods for producing a suitable access device to replace or supplement the original ones that came with a vehicle having an immobilizer system. Such vehicles typically include an original key that is a suitable match for the vehicle, commonly referred to as the master key. This typically is the original key that was shipped with the vehicle from the factory or the vehicle's original equipment manufacturer (OEM). These personal devices may be such things as a transponder key, an integrated remote head key (IHRK), a Finger Operated Button Integrated Key (FOBIK), a proximity key, a smart phone, a universal remote, a blue-tooth device, and/or any combination thereof.

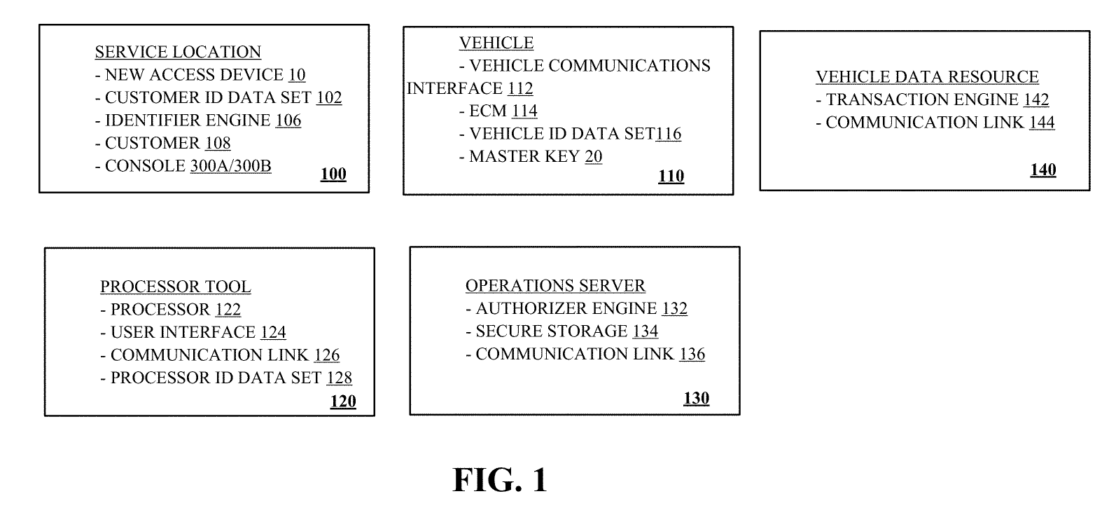

FIG. 1 is a block diagram of an example of the system that can execute implementations of the present disclosure. The system includes a service location 100. The service location 100 can be a fixed location or can be mobile. The service location 100 accommodates the customer 108 in search of a new access device 10 such as a transponder key. The customer 108 also typically is at the service location 100 together with the vehicle 110 that is associated with a master key 20 or other access device. The customer typically may be the registered owner of the vehicle but other customers with authority may be associated with the vehicle 110.

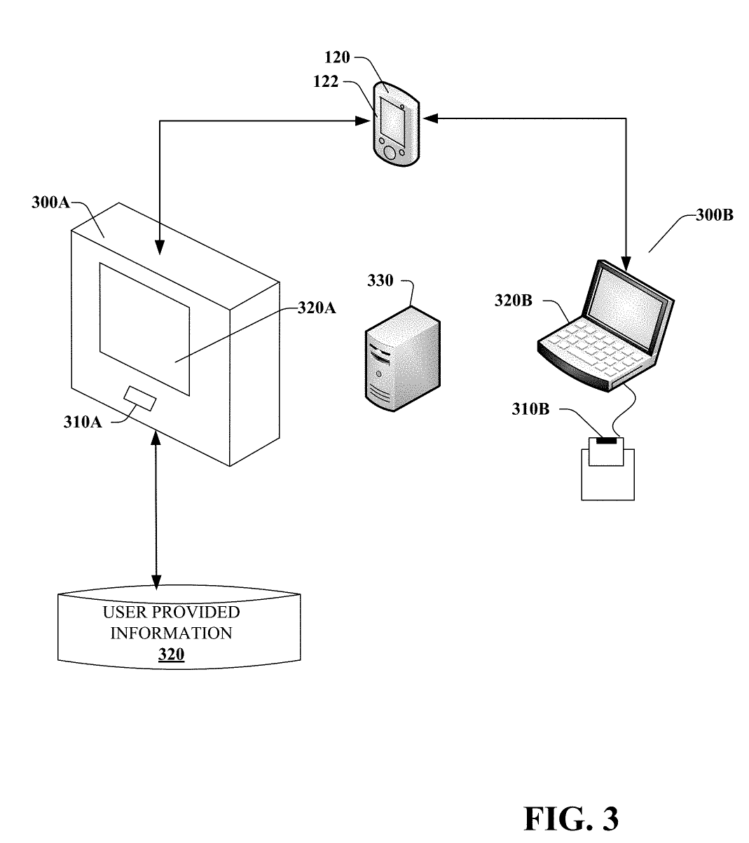

The customer 108 in this system also includes some form of positive identification such as a customer ID data set 102 and the service location 100 may include a console 300A, 300B shown by example in FIG. 3, with a logic also referred to here as an identifier engine 106. The identifier engine 106 could operate with such things as biometrics such as fingerprint, or could be a photo identification such as driver's license which could be swiped, copied, or photographed, and processed for data input to the identifier engine 106. The service location 100 also typically is the location where the owner/operator of a processor tool 120 interacts with the customer 108. Using the console 300A, 300B, the system operator and/or the customer may generate one or all of a vehicle identity data set 116, customer identity data set 102, and/or processor ID data set 128. It should be noted that any of the console 300A, 300B, identifier engine 106, or owner/operator of the processor tool 120 may be at a remote location and interact with the vehicle 110 and customer 108 using networked devices.

As used herein, the terms “logic” and “engine” includes but is not limited to hardware, firmware, software and/or combinations of each to perform a function or an action, and/or to cause a function or action from another logic, engine, method, and/or system. For example, based on a desired application or need, logic or engine may include a software controlled microprocessor, discrete logic, an analog circuit, a digital circuit, a programmed logic device, a memory device containing instructions, or the like. Logic or engine may include one or more gates, combinations of gates, or other circuit components. Logic or engine may also be fully embodied as software. Where multiple logical logics or engines are described, it may be possible to incorporate the multiple logical logics or engines into one physical logic or one physical engine. Similarly, where a single logical logic or engine is described, it may be possible to distribute that single logical logic or engine between multiple physical logics or engines.

The system and method of the present disclosure includes the vehicle 110 that the new access device 10 made by this disclosure is intended to access and/or operate. The vehicle 110 has an associated vehicle identity data set 116. This can be such things as the year, make, model of the vehicle (YMM), the vehicle registration, the vehicle identification number (VIN), the license plate number, etc. Sometimes this vehicle identity or a portion of it can be derived from the master key brought to the service location 100 by the customer. This identity information also can be brought into use though various input means to the console 300A, 300B or on the processor tool 120 itself and include the vehicle identity data set 116 component to the system.

The system includes a processor tool 120 that includes a processor 122. The processor tool 120 may be an OBD tool, key cutting equipment for standard keys or sidewinder type keys, or a cloning tool that may include the processor 122. The processor 122 may include memory and existing code or software that may receive and process various commands, such as a processor ID data set 128, from an operator or in communication with other nodes that will be described as part of this system. Such a device could be an OBD programmer, cloning tool, or key cutting machine. Such device could be located at the service location 100 or at some networked remote location.

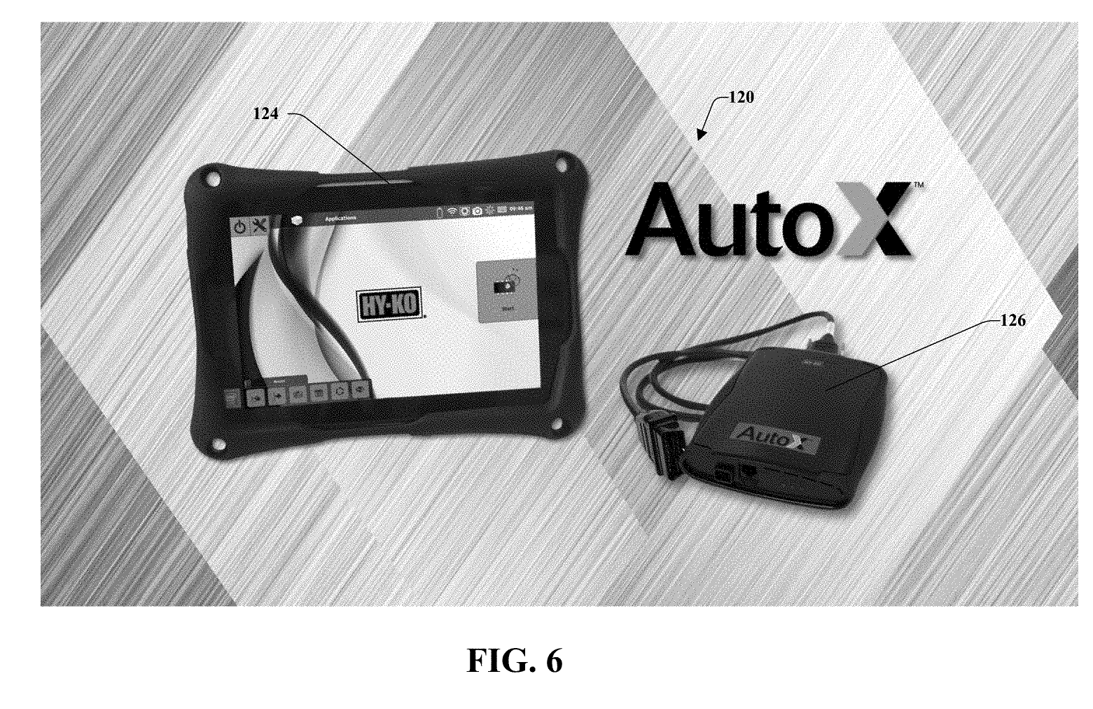

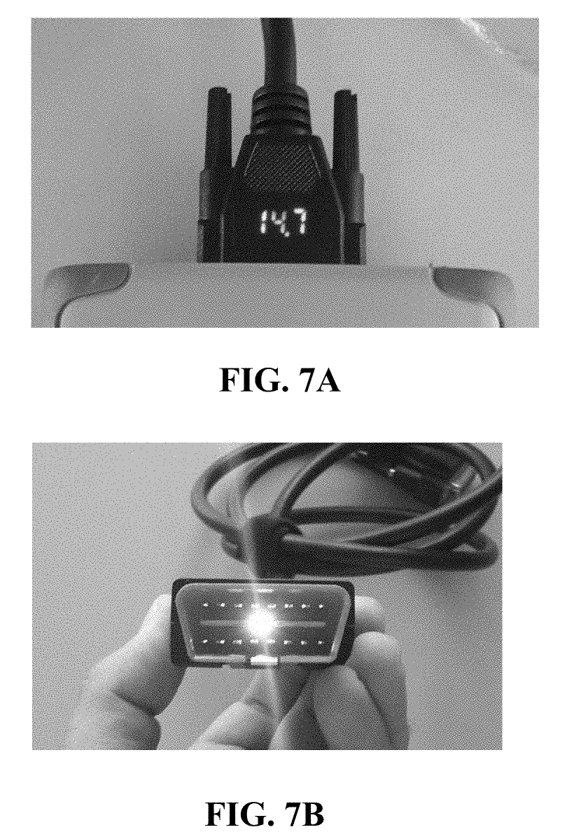

As illustrated by FIGS. 1 and 6, the processor tool 120 may include a communication link 126 to connect to a vehicle communications interface 112 such as an OBD port or other wired or wireless interface. The processor tool 120 may also include a user interface 124, such as a tablet having a touchscreen. The communication link 126 may send and receive data communications from the user interface 124 as well as the vehicle communications interface 112. The communication link 126 may be a vehicle control interface (VCI) that includes a housing having at least one electrical hookup for data and power. The VCI may also include a connector compatible with a vehicle OBD port. The VCI may also include an indicator, such as indicator lights positioned along the housing, that may identify the status of the processor tool 120. The indicator lights may identify various signals such as if there is a proper power or data connection, the presence of Wi-Fi or Bluetooth signals, or if data transmission is occurring. The connector may also include a signal indicative of a voltage readout (FIG. 7A) and a light (FIG. 7B) to assist a user to connect the connector to the OBD port of a vehicle.

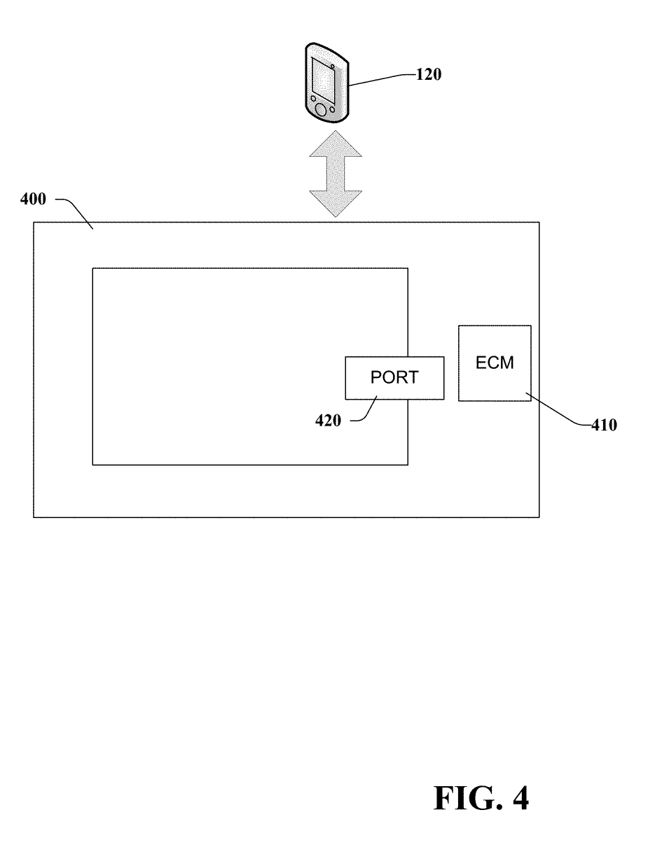

The communication link 126 may communicate with the user interface 124 in a wired or a wireless manner. The communication link 126 and the user interface 124 may communicate with a remoter server, such as an operations server 130, via wi-fi to download software updates or other downloadable material. These communications may be hardwired or wireless such as Bluetooth, Wi-Fi, cellular link, etc. In one preferred embodiment, the processor tool 120 links to the vehicle communications interface 112, 420 of the vehicle and executes a routine to reprogram a vehicle ECM 114, 410 (FIGS. 1 and 4) to recognize the new access device, such as a transponder key or remote. To do so, it typically must first unlock or bypass a security gate or protocol of the ECM 114, 410.

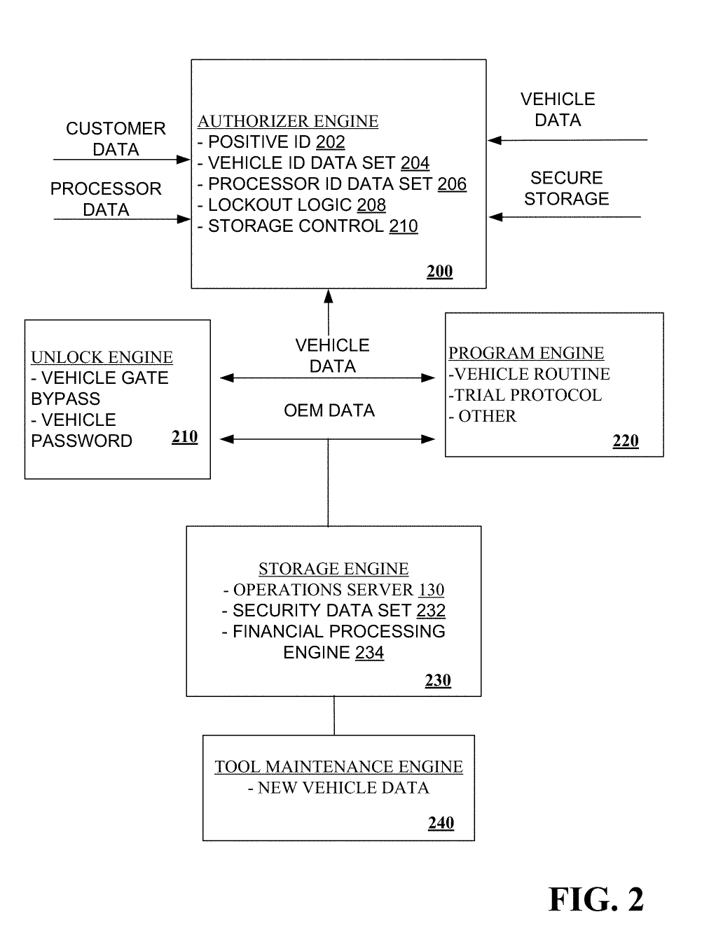

In one embodiment, the system includes an operations server 130 as shown in the block diagram of FIG. 1. Operations server 130 can share computing capability with the processor 122 and with the processor tool 120 and with other resources of the system such as the console 300A, 300B. Operations server 130 includes or is connected to a secure storage data location 134 represented as storage engine block 230 in FIG. 2. Operations server 130 includes a communications link 136 which could be hard wired or wireless much like the processor tool 120. The operations server 130 may include or be in communication with an authorizer engine 132, 200 to carry out the process and execute implementation of the present disclosure. The operations server 130 may be located at the service location 100 or at some networked remote location.

In one embodiment the system also includes a vehicle data resource 140. The vehicle data resource 140 allows for retrieval of data associated with the vehicle 110. The vehicle data resource 140 typically would include a transaction engine 142 to carryout authentication and/or to exchange data transmission with the processor 122 of the processor tool 120 and other components of the present disclosure. Vehicle data resource 140 includes a communication link 144 which may allow communication between the processor tool 120, the console 300A, 300B, and the operations server 130 through any of the means previously described, including wired or wireless, over an internet connection, network, Bluetooth, and other forms of wireless data links.

FIG. 2 is a diagram of an example of the system that can execute implementation of the present disclosure. The system includes authorizer engine 200 for processing inputs and data transfer to the system. These inputs and transfers may include customer data 102, processor data 128, vehicle data 116, and secure memory or storage data 134. Authorizer engine 200 includes a positive identification engine 202 for confirming the customer identity and/or authority for the operation of the system. This could be triggered by the operator activating a button on the console 300A, 300B to confirm that the customer's identity corresponds in some manner of identification presented such as a government issued photo ID that may be recorded in the console 300A, 300B by swiping the ID or by manual entry or by other means as discussed below.

Authorizer engine 200 takes input and generates a customer identity data set 102 (FIG. 1). In one embodiment, the customer identity data set 102 may be procured through user provided information 320 (FIG. 3) obtained from a customer identification card such as a state driver's license. The customer identification card can be photographed or scanned at the console 300A, 300B, or the processor tool 120, or some other scanning device as optical character recognition may be used to determine and input the customer's name to the customer identity data set 102. The customer identification card also could be swiped through a swipe device to retrieve customer information content. User provided information 320 also could be manually entered through a keyboard 320B or touchscreen 320A. In another embodiment, it could be obtained from the customer directly as well. The customer's photograph could be taken and facial recognition used to confirm a match to the government photo ID.

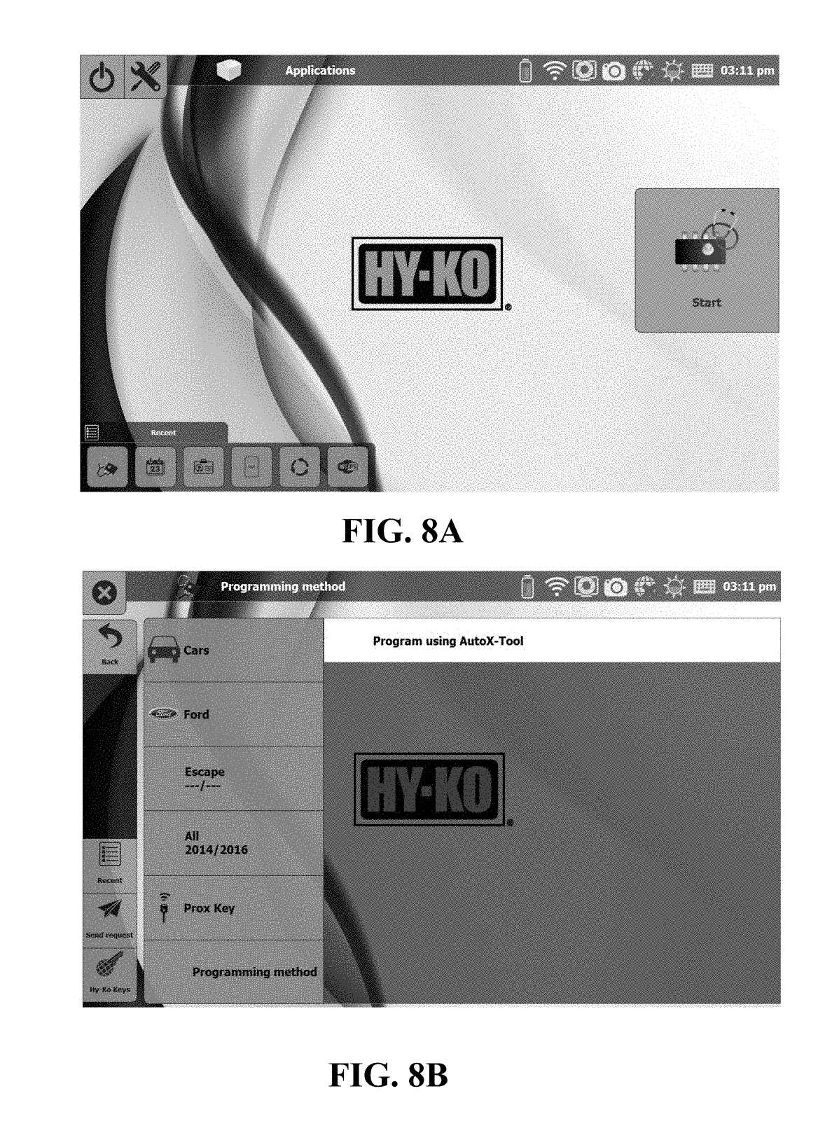

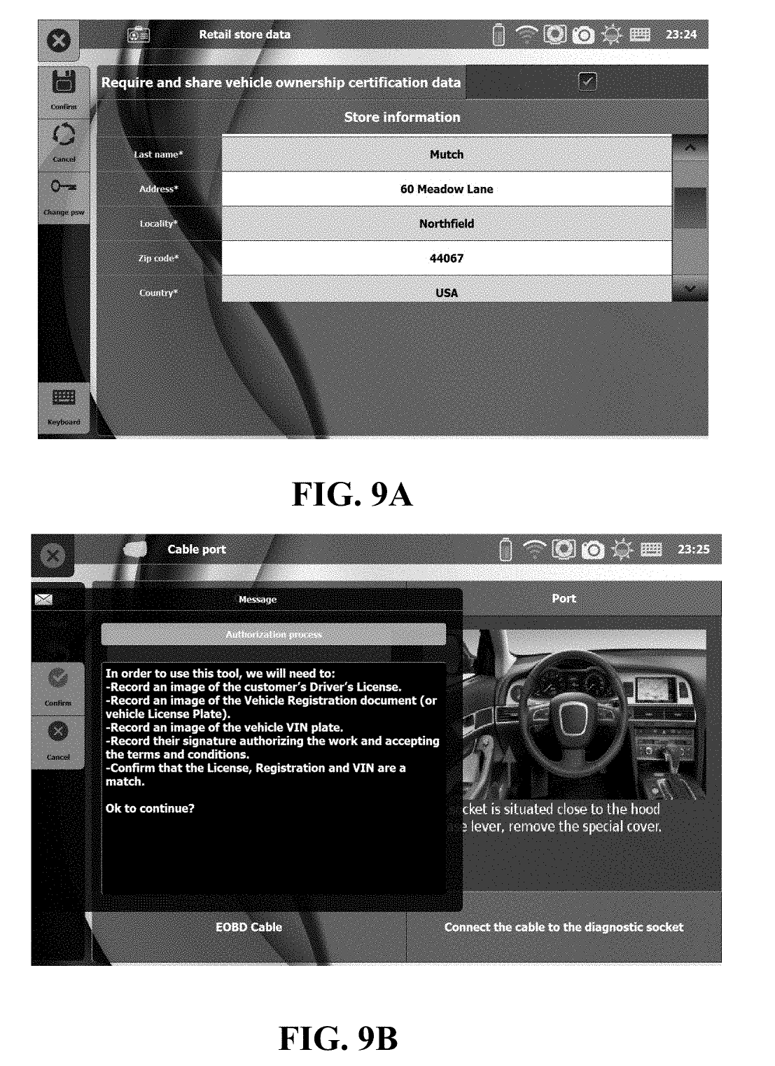

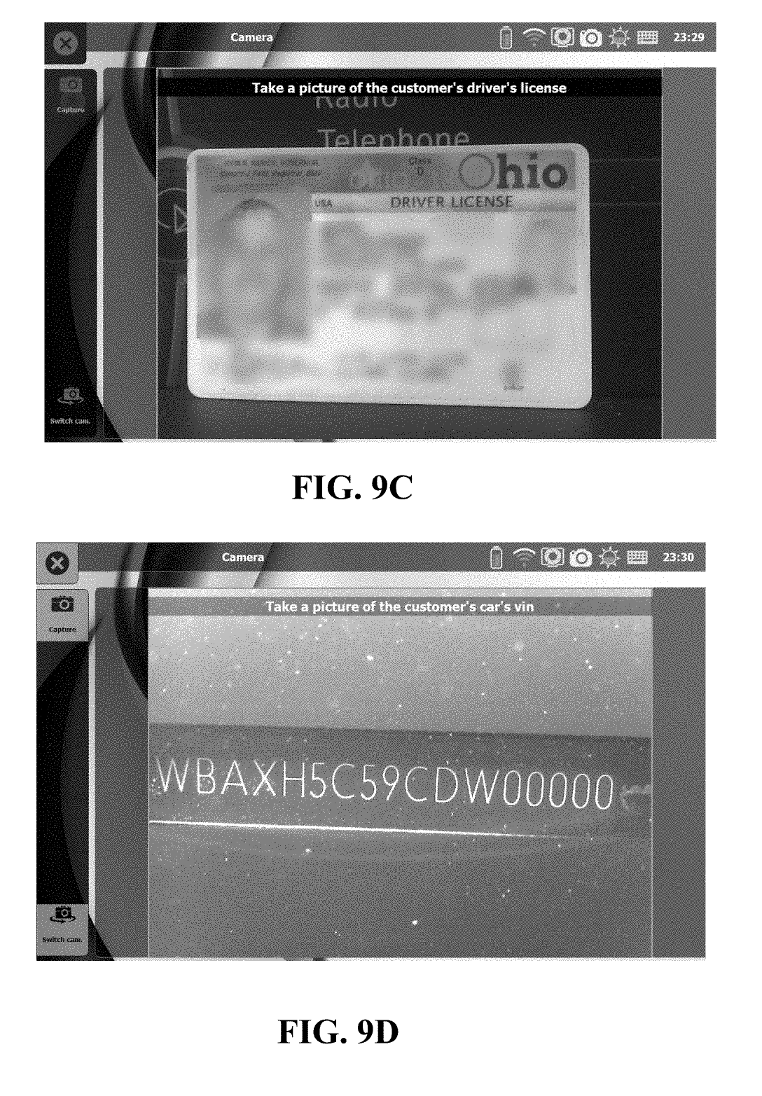

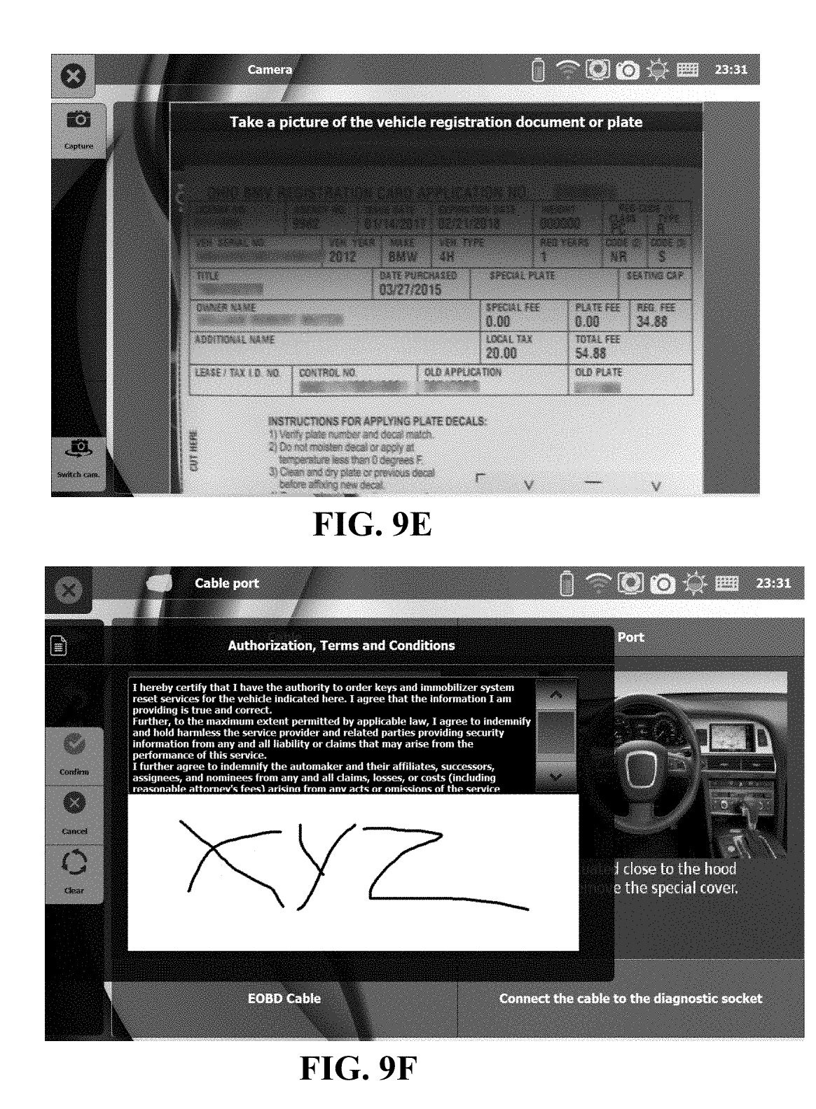

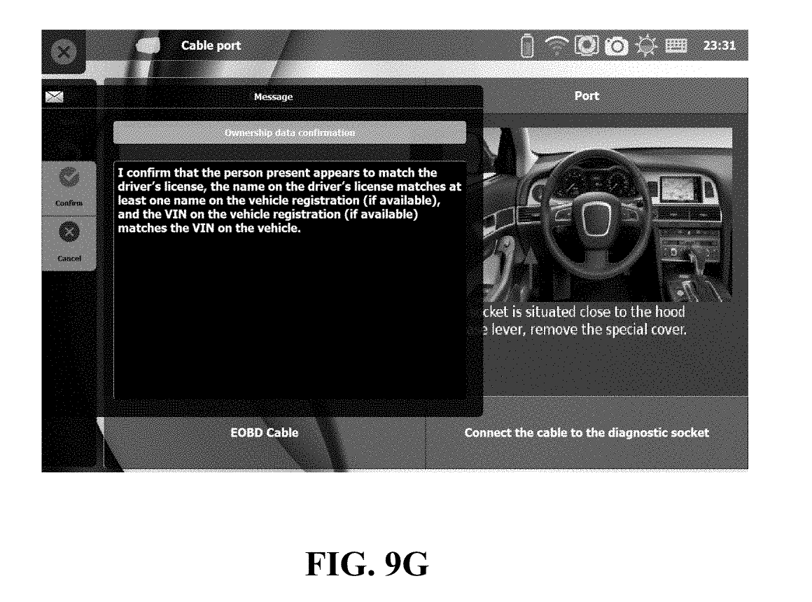

Authorizer engine 200 may also take inputs and generates a vehicle identity data set 116, 204. In one embodiment, this could be obtained from the vehicle title registration or insurance card. These documents could be scanned or photographed and, again, optical character recognition used to determine the VIN for inclusion in the vehicle identity data set 116, 204. This also may be accomplished by photograph of the license plate or the vehicle VIN taken from the plate mounted on the vehicle itself. It also could be manually entered using a keyboard or touchpad. FIGS. 8A and 8B illustrate embodiments of screen shots that may be displayed by the processor tool 120, or touchscreen 320A of the consoles 300A, 300B. FIGS. 9A, 9B, 9C, 9D, 9E, 9F, and 9G illustrate screen shots that may be displayed by the processor tool 120, or touchscreen 320A for the consoles 300A, 300B that prompts a user to input information related to the customer identity data set 102, vehicle identity data set 116, 204, and processor ID data set 128, 206 to assist with establishing authorization to implement the secure programming of vehicle access devices.

Authorizer engine 200 may also takes inputs and generates a processor ID data set 128, 206. In one embodiment, this could be a serial number that is unique to the processor tool 120 and embedded in the tool's memory when it is produced. The processor ID data set 128, 206 also could include some identifying code associated with the owner/operator of the processor tool 120 who conducts that particular origination/activation event, such as store employee number or NASTF Locksmith Identification (LSID) number.

The authorizer engine 200 may include a lockout logic 208 that may operate to prevent the origination/activation of a new access device 10 to be completed by the processor tool 120 unless this authorizing engine 200 has properly validated a match between the vehicle identity data set 204 and the customer authority/ownership data and/or completed the generation of the data sets for use by the storage engine 230. In the case of the customer identity data set 102, the authentication also could include other means such as taking a photo of the customer for inclusion in the data set, or using two-factor authentication using the customer's cell phone number, or other techniques including signature pads of the customer, biometrics or other verification or validation.

The system also may include a vehicle data resource 140 controlled by transaction engine 142. In one embodiment, this is a remote database such as that administered by NASTF linked to the system and provide OEM password or PIN data that originates from the various vehicle manufacturers. It also could be a direct link to the OEM database via communication link 144.

The lockout logic 208 of the authorizer engine 200 can include an unlock procedure which enables access to the vehicle ECM 114, 410. This protocol can be based on, among other things, contents of vehicle identity data set 116, 204, remote system input from vehicle data resource 140, or from a tool maintenance engine 240 or other inputs. Authorizer engine 200 also typically includes a programming protocol configured to perform a write function in the ECM memory 410.

An embodiment of the system includes unlock engine 210. Unlock engine 210 may be configured to gain entry for ECM read/write procedures. Unlock engine 210 may include vehicle-specific routines such as a vehicle gate bypass that provides access for writing to the memory in the ECM 114, 410. The gate bypass may have be developed or provided by the vehicle or tool manufacturer. Unlock engine 210 also may operate using a vehicle-specific password originating from the vehicle data resource 140. It could also operate from other data resources such as a user input or memory device provided by the customer or the tool operator.

An embodiment of the system includes program engine 220. Program engine 220 may be configured to execute implementation of a vehicle-specific routine for reading and writing to the ECM 114, 410 memory. It also can be configured to carry out a trial-and-error process for executing multiple programming sequences to find the right match. The choice of these and other potential programming routines typically is accomplished by the program engine 220 based upon contents of the vehicle identity data set 116, 204 and/or vehicle data resource 140, such as OEM data. These can be accessible directly through links to the OEM vehicle data resource or through an intermediary such as NASTF.

An embodiment the system includes storage engine 230. This includes components configured to provide permanent storage and later retrieval or redistribution of a security data set 232. This data set typically would include the registered identity of the processor tool 120, the consumer identity, vehicle identity, and other relevant data associated with the transaction such as date, time, location, operator, etc. This would provide a security data set 232 for later retrieval in the event that it was needed for insurance or law enforcement investigation purposes if something happens later to the vehicle. Engine 230 also may include a financial processing engine 234 to transmit authorizations and confirmations that the new device activation service is complete to operate the processor tool 120 or new device 10 and finalize the procedure.

In one embodiment, the system also includes a maintenance engine 240. Maintenance engine 240 is typically configured to import and/or develop new unlock or programming routines and conduct field testing. This provides feedback and new model year updating for implementation of the present disclosure.

As shown in FIG. 3, in one embodiment the system may include console 300A, 300B. The console may be a receiver such as a key duplication machine or cutting machine that optionally includes a receptacle 310A, 310B for placement of the master key 20. The receptacle may be sized and shaped and designed to receive a master key associated with the vehicle. The receiver also typically includes user input means such as a touchscreen 320A or keyboard 320B. The receptacle may be equipped to hold the master key in the proper position to detect electronic features of the master key and/or to capture an image of the master key such as its blade. One suitable receiver device for this purpose is disclosed in U.S. Pat. No. 7,891,919 which is hereby incorporated by reference in its entirety. Optionally, the identifying data could be read or input from the master key to the processor 122 and processor tool 120, which could include a touchscreen and/or reader or other suitable input means.

The system of this embodiment may provide a reader to capture a representation of the master key. This could be a visual image of physical features, such as the key blade or housing. It also could be a representation consisting of an electronic signature associated with the key which could be captured when the master key is placed in the receptacle 310A, 310B. This reader, optionally coupled with operator input, enables determination of the category to which the master key and/or vehicle belong. It may lock or unlock programming engines to perform operations on the vehicle ECM 114, 410 and may also assist in selecting an appropriate new off-the-shelf device to use for creating a new operable device 10.

The system also includes a memory and logic to control operation either locally or in remote server 330. One feature of the logic and memory involves storage of known vehicle types. Another feature is logic that compares the representation of the master key by the receptacle 310A, 310B mentioned above or other input arrangements against known representations stored in memory to assist in determining the group of vehicle types to which the master key belongs and/or the type of suitable key blank to use for programming the new access device 10. This could be performed with or without operator data input.

The present disclosure could include systems and methods of U.S. Pat. Nos. 7,849,721 and 7,890,878 and 8,634,655 and 8,644,619 and pending application Ser. No. 62/200,208. The disclosures of U.S. Pat. Nos. 7,849,721 and 7,890,878 and 8,634,655 and 8,644,619 and application Ser. No. 62/200208 are hereby incorporated by reference in their entireties.

The system provides an operator user interface 320A, 320B or one located in the processor tool 120 or one located on the remote server 330. Among other things, this allows the operator to make a choice of vehicle type or similar data from among the possible selections narrowed down by the logic as described above.

The system also provides a suitable new key blank or other new device for origination/activation at service location 100 and/or vehicle location to create the new access device 10. The key blank would include components to function as a transponder key or other remote signal transmission consistent with the master key device 20 and/or the vehicle. It could have a writable memory location or a pre-established identity code or other variations that serve as a unique identifier of that key blank. The processor tool 120 may include operator controls, such as a touchscreen 121, to perform the creation of a proper new access device.

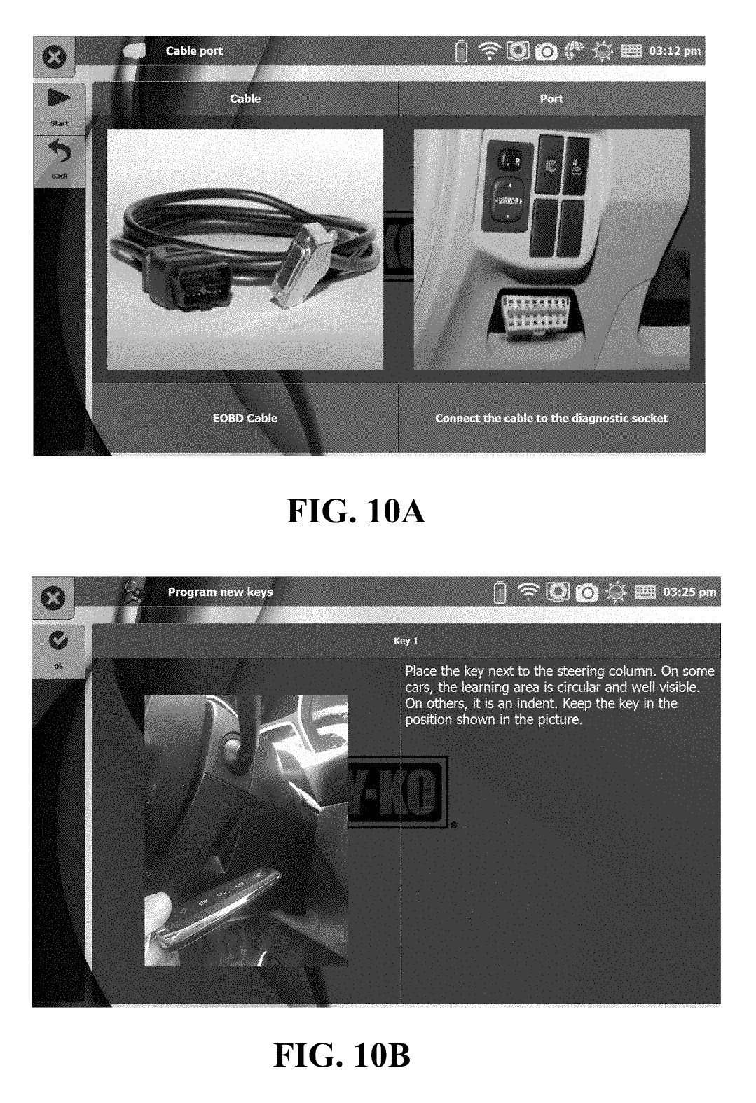

As illustrated by FIG. 4, the processor tool 120 may be portable and may interact with the vehicle ECM 410. The processor tool typically would be taken to the vehicle 400 to perform its functions after the operator has performed initial steps at the service location 100 using the master key 20 and/or the customer 108. It could be connected to the vehicle electronics port 420 using a standard connection or by other means such as a wireless connection. Here, the cable may be connected to the OBD port of the vehicle. See FIG. 10A. The access device 10 may also be positioned within the vehicle such to communicate with the vehicle as illustrated by

FIG. 10B.

In one embodiment each processor tool 120 of the overall system would separately be registered to perform occasional authentication with the operations server 130, remote server 330, storage engine 230 or other processor. This authentication could be executed with each transaction originating from the processor tool 120 to verify the source and responsible operator of that processor tool 120 and origination event.

The processor tool 120 may be subject to a registration process that may require and capture suitable background check information as deemed appropriate by the relevant laws or law enforcement authorities of the service location. It also could require a periodically changing password to be entered by the operator before each replication event.

The processor tool 120 may include a user input, such as a touchscreen 124, and communication link 126 to communicate with the vehicle ECM 114, 410. This could be hardwired connections that ultimately lead to the vehicle standard port 420 such as an OBD port. The tool could be divided into two or more components in communication with each other. For example, the user component could be a hand held unit or remotely operated unit that primarily provides the user interface such as a touchscreen while a complementary unit, such as a VCI 126, would provide the bulk of the electronics and software for processing and interface via port 420 with the vehicle network in the ECM 410. Any link among these units and the vehicle could be provided with other communication links such as Bluetooth, wireless network, etc.

The console 300A and 300B of FIG. 3 may be in communication with the processor tool 120 either before or during the time the processor tool 120 is taken to the vehicle 110, 400. In one embodiment, the authorizer engine 200 communicates with the processor tool 120 to initiate actions according to the type of immobilizer system on the vehicle 400 that is associated with the master key 20 and/or customer 108, such as whether it requires a password or other mode for programming or routine to activate the new access device 10. For example, a logic could be configured by which the processor tool 120 requires an authorizing signal from the authorizer engine 200 before it is enabled to carry out the replication routine. The system includes a logic as part of the authorizer engine 200 or operations server 130 to assess which unlocking and programming protocol is appropriate for unlock engine 210 and programming engine 220. The authorizer engine 132, 200, storage engine 230, unlock engine 210, program engine 220 engines and associated logic could be located in any hardware component of the system provided that the communication links among them have sufficient bandwidth to communicate and coordinate the processing.

The system includes the unlock engine 210 to enable access to the relevant portions of the ECM for programming to accept the new access device 10. As one means of programming access, the operations server 130 and authorizer engine 200 enables communication with the transaction engine 142 of the vehicle data resource 140 to obtain transaction data from the OEM via cellular network or internet or via an intermediary of the OEM that would enable operation of the processor tool 120 on the vehicle's immobilizer system such as NASTF. This input device could operate through a variety of communication channel or mediums such as internet, cellular links, etc.

In one embodiment, once the authorizer engine 200 has obtained and received information from the vehicle data resource 140, the system logic communicates the necessary instruction to the processor tool 120 for operation of the unlock engine 210 and the program engine 220. The security data set 232 is generated that could include, for example, the vehicle's VIN, vehicle ownership or registration data, customer identity data such as driver's license registration number, the personal or store identity of the person operating the tool, customer biometrics, etc. In one embodiment, each security data set is joined with the registration data of the processor tool 120 that was used in the replication event.

This system provides a confirmation signal to the processor tool and/or tool operator before the programming of the ECM can be successfully completed. In one embodiment, the storage engine 230 may be a remote long-term storage location that receives the security data 232 and sends back a signal confirming its receipt and storage before the processor tool 120 is free to prompt the operator to continue with the programming step. Until that data storage is confirmed, the processor tool 120 may lock out the operator from completing the process at the vehicle ECM.

The transaction data could be retained in the secure data storage indefinitely for future traceability of the replication event with reference to the security control and quality control and to comply with the needs or demands of law enforcement, insurance providers, or other regulatory sources. This would provide a record linking the tool, its owner/operator, and the customer with the vehicle and with the replication transaction that created a new access device 10. This would be accessible for future reference in the event the vehicle is later lost or stolen, thereby overcoming the security problems of the prior art systems, devices, and methods. In this way, each immobilizer and/or replication event would capture security data to guard against misuse of the system and potential vehicle theft. Until the system confirms that the customer has authority and/or that the security data has been stored and locked in long term storage location under the control of the processor tool and/or system provider, the system preferably may not proceed to the final steps.

In the past, duplication systems by vehicle programming were unable to ensure that such traceability data was generated and stored, which led to untraceable identity/vehicle thefts. The invention of this disclosure provides a level of security that solves that problem while at the same time providing increased flexibility, fast service, and easier records retention.

In one embodiment in operation, the operator would begin by inputting to the system the type category of the master key and/or the vehicle such as a Ford Escape. This could be done automatically or semi-automatically using the reader or using another input means carried out by the operator, or the customer, or any combination of these, either on the processor tool itself or otherwise as illustrated in FIG. 3 for example by a preliminary step in the store at the console.

The operator and/or customer would also input customer identity data. This could include information such as, for example, social security number, driver's license number, name and address, vehicle registration, insurance card information, etc. It could be input by scanning, data entry, optical character recognition, or a facial photograph or the like.

This vehicle data input could occur at the receiver 310 or console 300A, 300B depicted in the Figures and appropriate signals indicating Ford Escape then transferred by the system to enable the processor tool 120 by wired or wireless communication for interaction with the immobilizer of the vehicle 110, 400. As mentioned above, this transfer could be accomplished by the operator and/or by a fully or semi-automatic fashion via the operations server 130 or authorizing engine 200 or both. Such information regarding vehicle type would be communicated to the processor tool 120 for use in the vehicle interaction. Once the operator is at the vehicle 400 with the processor tool 120 as shown in FIG. 4, a communication link is established to the vehicle using one or more of the vehicle communications interface 112 types described above such as an OBD port or other wired or wireless connection to the vehicle 110.

At some point in time before or during the connection between the processor tool 120 and the vehicle 110, 400, the system optionally could communicate to a vehicle data resource 140 such as with the vehicle's OEM, Ford Motor Company in this example, or an intermediary to receive an authorization code or protocol instruction for the authorizing engine that would enable access through the security restrictions of the vehicle's immobilizer system. For example, the system may obtain a PIN code for that particular Ford Escape from the OEM or via NASTF.

In this example, the system unlock engine 210 would include a pass code bypass logic configured to access memory for reprogramming to accept the new access device 10 or key and thereby create a replica of the master key 20. In either case, the system of the present disclosure would associate the immobilizer and/or replication event with the processor tool 120 and the registration identity. The system may record the pertinent ownership data and other relevant information making up a predetermined security data set in a secure location for future use in the event of a later vehicle theft. Until that or an equivalent recording of the transaction has been confirmed, the system could block the operator from completing the replication event. This provides a technology based theft prevention that overcomes human vulnerabilities and human error.

The communication link to the OEM or its proxy could also transmit a permission signal to allow the programming of the key as a result of meeting one or more minimum criteria. Such criteria may include entering of vehicle information, verification of vehicle ownership, archiving of vehicle ownership data, confirmation of payment, verification of available programming tokens, recording use of programming token(s), or validation of the new key blank as being genuine certified product.

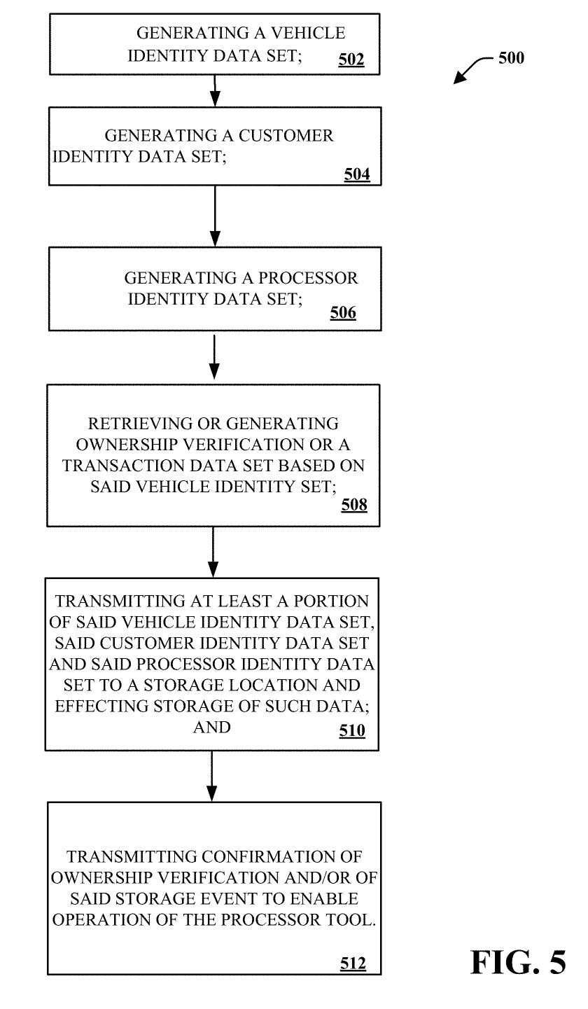

FIG. 5 illustrates a schematic diagram of a method 500 of the present disclosure. Provided is a secure network of devices for activation of a personal device to function with a vehicle immobilizer system. This network may include a non-transitory computer-readable medium coupled to computing devices on the network having instructions stored thereon which, when executed by such computing devices, cause the network to perform operations. In step 502, a vehicle identity data set may be generated on at least one of the computing devices in the network. In step 504, a vehicle identity data set may be generated on at least one of the computing devices in the network. In step 506, a processor identity data set may be generated. In step 508, ownership verification or a transaction data set based on said vehicle identity set may be retrieved or generated on at least one of the computing devices. A processor tool may be provided having an operator interface and communication links to assist in any one of the steps in the instant method. Said transaction data set may be retrieved from an authorization source and be based on said vehicle identity set and said operator identity set. In step 510, at least a portion of said vehicle identity data set, said customer identity data set and said processor identity data set may be transmitted to a storage location and effecting storage of such data. In step 512, confirmation of ownership verification and/or of said storage event may be transmitted to at least one of the computing devices to enable operation of the processor tool. As such, a new activation device 10 may be securely replicated or created after authentication of the identity of the customer, vehicle, and processor tool have been recorded in a storage location.

Other security features could be built into the system and/or its method. For example, the key blanks could include predetermined stored electronic markers. With that or a similar tag, the system engines and logic then could be configured to accept and enable only those key blanks having a suitable predetermined electronic marker or tag. This would speed operation of the system and provide improved quality control over known techniques.

In one embodiment, the system also provides a printed or electronic record. It prints a receipt with the necessary transaction data in the event regulators wish to have such records and to give the customer assurance that the replication event is properly documented. A hard copy of this record could be retained as needed and, if appropriate, an electronic copy transferred to the DMV authorities for the state in which the vehicle is registered and has a license plate.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

What is claimed is:

1. A system for replication of access devices used with a vehicle having an immobilizer system and a vehicle communications interface, comprising:
means for inputting customer identity data;
means for inputting vehicle identity data;
means for authenticating ownership of the vehicle by the customer; and
a logic configured to prevent replication until said authentication has occurred.

2. A system according to claim 1 further comprising a logic configured to prevent replication until at least a portion of said data has been securely stored.

3. The system according to claim 1 further comprising a processor tool for inputting said customer identity data and said vehicle identity data.

4. The system according to claim 1 wherein said processor tool includes a touchscreen.

5. The system according to claim 1 further comprising a console for inputting said customer identity data and said vehicle identity data.

6. The system according to claim 1 further comprising a console that includes a receiver device equipped to detect electronic features of a master key.

7. The system according to claim 1 further comprising a console that includes a receiver device equipped to capture an image of a master key.

8. A secure system for activation of a personal access devices to function with a vehicle having an immobilizer system comprising:
a console configured to receive input data selected from one or more of the categories including a vehicle identity data, a customer identity data and a processor identity data and having a communication link;
a processor tool having a communication link;
a communication link between said console and said processor tool configured to communicate input data to the processor tool;
a logic configured to communicate selected portions of said input data to an authorization unit and receive a processor transaction data set in response;
a secure storage configured to store selected portions of said input data and transmit confirmation of such storage to enable operation of said processor tool.

9. The system of claim 8 wherein said console further comprises a receptacle configured to communicate with a master key and a reader configured to collect data selected from the group consisting of physical features of the blade or detected features of the electronic components.

10. The system of claim 8 wherein said processor tool includes an operator interface.

11. The system of claim 8 wherein said vehicle identity data includes at least one of a year-make and model of a vehicle (YMM), a vehicle registration, a vehicle identification number, and a license plate number.

12. The system of claim 8 wherein said customer identity data is procured by at least one of the processor tool, a scanning device, a swipe device.

13. The system of claim 8 wherein said customer identity data is manually entered.

14. The system of claim 8 wherein said processor identity data includes at least one of a serial number that is unique to the processor tool and an identifying code associated with the owner/operator of the processor tool.

15. The system of claim 8 wherein said selected portions of said input data stored with the secure storage may be processed through a positive identification engine for confirming customer identity and/or authority for the operation of the system.

16. A computer-implemented method for activation of a personal device to function with a vehicle immobilizer system comprising:
generating a vehicle identity data set;
generating a customer identity data set;
generating a processor identity data set;
providing a processor tool having an operator interface and a communication link;
authenticating ownership of said vehicle by said owner; and
blocking operation of said processor tool until said authentication is complete.

17. A method according to claim 16 further comprising:
retrieving from an authorization source a transaction data set based on said vehicle identity set;
transmitting at least a portion of said vehicle identity data set, said customer identity data set and said processor identity data set to a storage location and effecting storage of such data; and
transmitting confirmation of said storage event to said processor tool to enable operation of the processor tool.

18. A system for activation of a personal device to function with a vehicle immobilizer system comprising:
a non-transitory computer-readable medium coupled to the computing devices on the network having instructions stored thereon which, when executed by such computing devices, cause the network to perform operations comprising:
generating a vehicle identity data set;
generating a customer identity data set;
generating a processor identity data set;
providing a processor tool having an operator interface and a communication link;
retrieving from an authorization source a transaction data set based on said vehicle identity set and said operator identity set;
transmitting at least a portion of said vehicle identity data set, said customer identity data set and said processor identity data set to a storage location and effecting storage of such data; and
transmitting confirmation of said storage event to said processor tool to enable operation of the processor tool.

19. The system according to claim 18 further comprising a console that includes a receiver device equipped to detect electronic features of a master key.

20. The system according to claim 18 further comprising a console that includes a receiver device equipped to capture an image of a master key.
